(19) United States
(12) Patent Application Publication
(10) Pub. No.: US 2025/0370772 A1
(43) Pub. Date: Dec. 4, 2025

(54) Virtual Bookplates For Electronic Media And Related Systems And Methods

(71) Applicant: Apple Inc., Cupertino, CA (US)

(72) Inventor: Ching-Lan Huang, Santa Clara, CA (US)

(73) Assignee: Apple Inc., Cupertino, CA (US)

(21) Appl. No.: 18/680,656

(22) Filed: May 31, 2024

(51) Int. Cl. G06F 9/451

(52) U.S. Cl. CPC G06F 9/451

(57) ABSTRACT

Techniques for generating and using virtual bookplates for electronic media are disclosed. When a digital content item, such as an eBook, is purchased, a virtual bookplate is generated and linked to the eBook providing a customization to the eBook. The virtual bookplate includes various content, such as a message from the purchaser, a signature, audio content, publisher content, and/or graphical content related to the eBook. Generative models produce graphical and/or audio content included in the virtual bookplate. The virtual bookplates are used and displayed in various ways by an eReader application in association with the eBooks to which the virtual bookplates are linked.

### TECHNICAL FIELD

The present disclosure generally relates to virtual bookplates for electronic media, such as electronic books, and related systems and methods.

### BACKGROUND

Electronic books, or “eBooks,” are digital versions of traditional printed books that can be read on electronic devices, such as computers, tablets, smartphones, and dedicated e-readers. eBooks typically contain text, sometimes images, and can be designed to be read using various e-reader software or apps. Online retailers and publishers sell or lend eBooks via various platforms.

Once purchased or licensed, eBooks can be downloaded directly to a user's device or accessed through cloud storage. eBooks can be read using dedicated e-reader devices, tablet computers, smartphones, or desktop/laptop computers depending on the file format and compatibility. E-reader apps offer various features for eBooks, like adjustable font sizes, bookmarks, highlighting, and search functionality to enhance the reading experience.

### OVERVIEW

In some embodiments, a computing device generates, stores, and/or displays one or more virtual bookplates. A virtual bookplate is associated with a digital media content item, such as an electronic book or other digital media. The virtual bookplate appears in an interface associated with displaying the digital content item and can be used in various ways as a part of the interface. In various examples, the virtual bookplate is presented in the interface prior to, concurrently with, or after the digital content item is presented. In another example, the virtual bookplate is displayed in the interface by rendering the virtual bookplate over a graphic representation of the digital content item. The system may graphically wrap the digital content item over the virtual bookplate.

Details of one or more embodiments are set forth in the accompanying drawings and the description below. Other features, aspects, and potential advantages will be apparent from the description, drawings, and claims.

### DESCRIPTION OF DRAWINGS

FIGS. 1 and 2 illustrate block diagrams of virtual bookplate systems in accordance with one or more embodiments.

FIG. 3 illustrates a method of generating a virtual bookplate in accordance with one or more embodiments.

FIG. 4 illustrates a method of providing a virtual bookplate in accordance with one or more embodiments.

FIGS. 5A and 5B illustrate flow diagrams for selecting a virtual bookplate and presenting a virtual bookplate in association with a digital content item in accordance with one or more embodiments.

FIGS. 6A-6F illustrate examples of using a virtual bookplate system.

FIG. 7 illustrates a block diagram of an example computing device that can implement the features, processes, and workflows of FIGS. 1-6F.

Like reference symbols in the various drawings may indicate like elements.

### DETAILED DESCRIPTION

### Example Virtual Bookplate System

In various embodiments, one or more client devices execute applications used to present content and/or access a content store. A particular example is an eReader application used to present an eBook. However, this is exemplary in nature and aspects disclosed herein apply to other media types and/or content application types in addition to eBooks and eReaders.

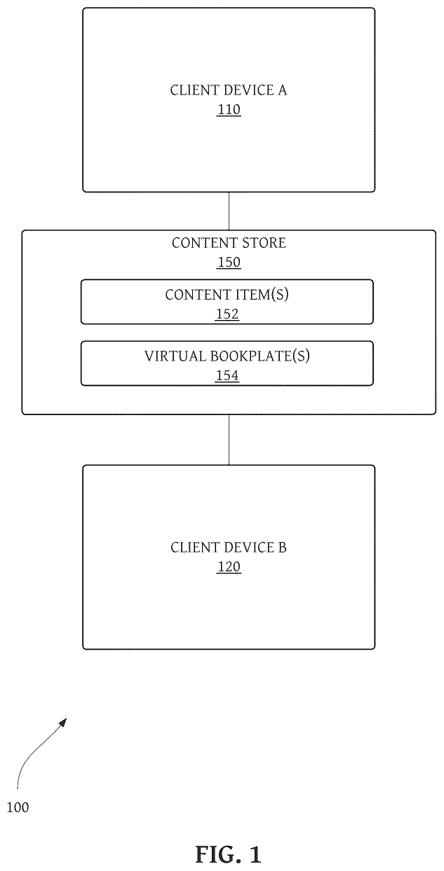

FIG. 1 is a block diagram of an example virtual bookplate system 100. In FIG. 1, the virtual bookplate system 100 includes client device A 110, client device B 120, and content store 150. The content store includes one or more digital content items 152 and one or more virtual bookplates 154.

In the example, client device A 110 is a computing device that accesses the content store 150. The client device 110 is a purchasing or obtaining device. In other words, client device A 110 is used to purchase, obtain for free, and/or gift one or more digital content items 152 from the content store 150. Client device A also purchases, obtains for free, and/or gifts one or more virtual bookplates 154 associated with the one or more digital content items 152. In various embodiments, the digital content item is an eBook that is purchased from an eBook store and viewed using an eReader application. The content store interface provides a catalog of available digital content items (eBooks), organized by category, genre, or other criteria. The user navigates through the content store interface to explore different content options and selects a digital content item of interest for purchase or to be added or gifted to an account.

Continuing the example, client device B 120 is a recipient device. Client device B 120 receives the one or more digital content items 152 and/or the one or more virtual bookplates 154 associated with the one or more digital content items 152 from the content store 150. For example, a user of client device A 110 indicates a selection using an interface of the client device A 110 to select a specific digital content item and initiates the process to obtain or provide access to it. The user confirms the selection, triggering a request to the content store server to retrieve or authorize access to the chosen digital content item.

In embodiments, client device A 110 accesses the content store 150 from a first user account. The first user account is used to purchase or otherwise obtain the digital content item(s) 152 and/or the virtual bookplate(s) 154. A virtual bookplate 154 is linked to a content item 152 and not to other variations of the same content item 152 (e.g., other copies of the same eBook).

Client device B 102 accesses a second user account, where the digital content item(s) 152 and/or the virtual bookplate(s) 154 are received as a result of being purchased or obtained for free and gifted by the first account to the second account. In various embodiments, the virtual bookplate includes a message from the sender (text and/or audio), a signature, and/or other content. The virtual bookplate is used to customize an eBook.

In the example, the first user account is used to gift the digital content item(s) 152 and virtual bookplate(s) 154 to the second, recipient user account. However, the first user account can also be used to purchase or otherwise obtain the digital content item(s) 152 and virtual bookplate(s) 154 without gifting to a recipient account. If gifted, a digital content item 152 and associated virtual bookplate 154 are transferred to the recipient account, where the digital content item and the associated virtual bookplate are accessed using client device B 120.

The content store 150 includes a plurality of different digital content items 152. In embodiments, the content store 150 includes a plurality of eBooks. In response to an eBook being purchased or selected, the content store 150 provides an option to purchase or select a virtual bookplate 154. Custom virtual bookplates 154 are generated and provided via the content store 150 for purchase or selection. In some embodiments, however, virtual bookplate content is unaltered content provided to content store 150 by a publisher of the digital content item 152.

In embodiments, one or more virtual bookplates are generated automatically using an image bank and/or a generative image model. The automatically generated virtual bookplates are signed and provided with an attached message based on input from user device A 110 via a virtual bookplate editor interface. In another embodiment, the virtual bookplate editor interface includes one or more advanced image editing tools.

The virtual bookplates are linked to digital content items. Digital content items, such as eBooks or virtual bookplates, are linked to user accounts and to each other via digital rights management, account management, and/or content management systems. For example, content management systems link content items, such as an eBook and virtual bookplate, using databases, structural links, and/or metadata. Additionally, or alternatively, a virtual bookplate configuration is linked to the digital content item. The virtual bookplate configuration is used to configure a virtual bookplate at runtime in response to the digital content item associated with the virtual bookplate configuration being selected.

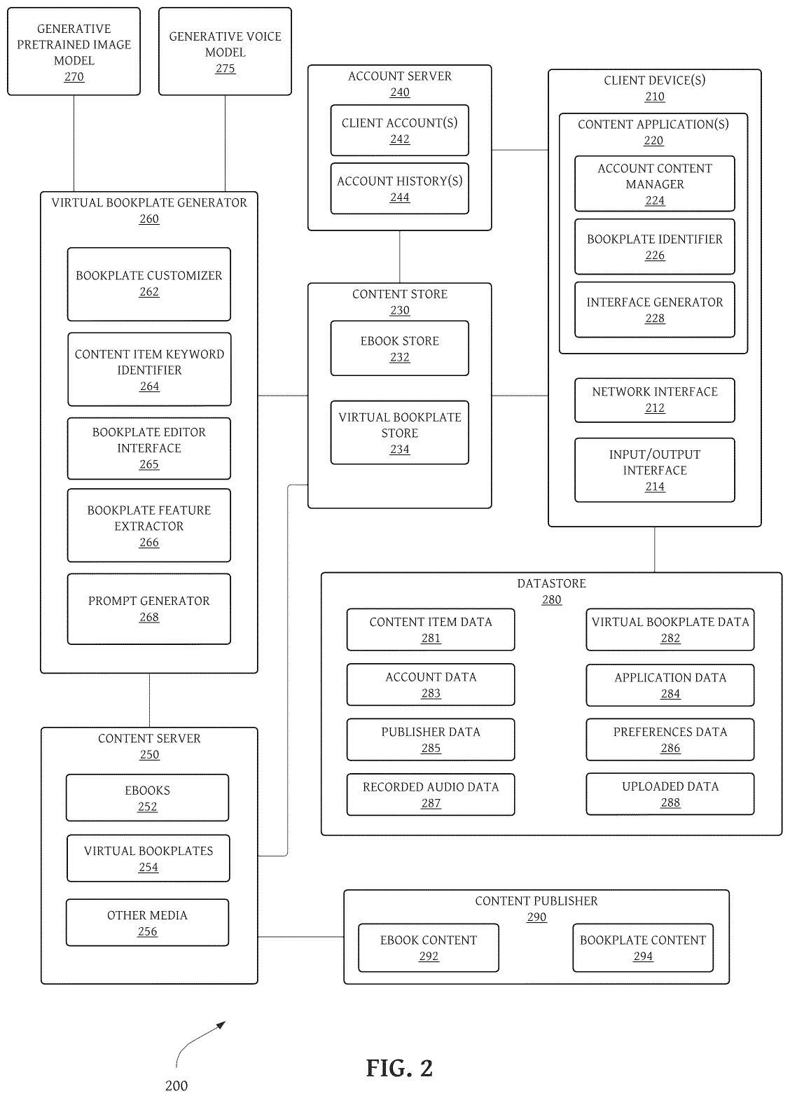

FIG. 2 illustrates a block diagram of an example virtual bookplate system 200. In FIG. 2, the example virtual bookplate system 200 includes one or more client devices 210, a content store 230, an account server 240, a content server 250, a virtual bookplate generator 260, a Generative Pretrained Image Model (“GPIM”) 270, a Generative Voice Model (“GVM”) 275, a datastore 280, and a content publisher 290.

In FIG. 2, one or more client devices 210 are computing devices (such as client device A 110 and/or client device B 120) used to access the content store 230 and/or to access one or more content applications 220 executing on the client device 210. The client device 210 also includes a network interface 212 and/or an input/output (“I/O”) interface 214.

In FIG. 2, a content application 220 includes an account content manager 224, a virtual bookplate identifier 226, and an interface generator 228. In various embodiments, content application 220 is an application that displays or otherwise presents a digital media content item, such as an eBook. In an example, the content application 220 is an eReader for displaying eBooks on a display of the client device 210. However, this is exemplary and not limited in nature; aspects of the virtual bookplates described herein can also be applied to digital audio books, eMagazines, eNews, podcasts, video, apps, and/or other digital media content items presented by various content applications 220.

The account content manager 224 performs operations and/or services related to managing and validating digital content items for content application accounts. The account content manager 224 also includes controls adjusting or altering how content is displayed for an account. In various embodiments, the account content manager 224 provides controls for various account content settings, such as if eBooks and/or virtual bookplates associated with an account are locally or remotely stored.

The virtual bookplate identifier 226 performs operations and/or services that identify, locate, transfer, and/or otherwise obtain a virtual bookplate associated with a particular digital content item. The virtual bookplate identifier identifies and/or selects a virtual bookplate based on a virtual bookplate being associated with a digital content item in an account.

The interface generator 228 generates an interface displaying the digital content item and the identified associated virtual bookplate. In various embodiments, the interface generator 228 generates interfaces that are templates displaying eBook content and/or a virtual bookplate overlaid onto or in association with eBook content.

The network interface 212 connects the client device 210 to other network entities. A network interface, often abbreviated as NIC (Network Interface Card) or network adapter, is a hardware component that facilitates the client device 210 connecting to a network. Examples of network interfaces include Ethernet cards, Wi-Fi adapters, and modems. Ethernet cards are used in desktop computers, servers, and network switches to connect to wired Ethernet networks; Wi-Fi adapters enable devices like laptops, smartphones, and tablets to connect to wireless networks. Modems provide connectivity to the internet over various types of connections like DSL, cable, or fiber.

The input/output interface 214 is used to accept input or provide output. The I/O interface is the mechanism through which the client device interacts with external devices or a user for input or output operations. Examples of input/output interfaces include Universal Serial Bus (USB) interface, High-Definition Multimedia Interface (HDMI), or any other interfaces used to connect devices, such as keyboards, mice, external hard drives, printers, cameras, computers, gaming consoles, Blu-ray players, TVs, projectors, external storage drives, monitors, docking stations, or the like.

The content store 230 provides a platform for facilitating access to various content, such as eBooks or other digital media content items. The content store 230 includes an eBookstore that provides eBooks in association with the content application 220.

The content store includes an eBook store 232 and a virtual bookplate store 234. The eBook store 232 includes eBooks for selection and/or purchase. Some eBooks contain the same content as a printed book, including text, images, and sometimes multimedia elements, like audio or video. eBooks come in various file formats, sometimes depending on the target device used to read or view the eBook. eBooks also include adjustable font sizes, search functionality, and the ability to highlight and take notes.

The content store also includes a virtual bookplate store 234. In an embodiment, when an eBook is selected for purchase, an option is presented to select or purchase a virtual bookplate to be associated with the eBook. Virtual bookplates are purchased for eBooks using the virtual bookplate store 234 as a purchasing or selection platform.

The account server 240 includes information and services related to one or more client accounts 242. The one or more client accounts 242 possess digital content items that have been purchased or otherwise selected for ownership by the accounts. eBooks and/or virtual bookplates are purchased and owned by the client account(s) 242. The one or more account histories 244 include a purchase history, gift history, selection history, use history, and/or other information about historical client account events.

The content server 250 is a server that stores, manages, and/or delivers digital content over a network to other devices, such as client device(s) 210, other computing devices, or other servers. The content server 250 distributes content such as eBooks 252, virtual bookplates 254, and/or other media 256. The content server 250 distributes the content to the content store 230 for access via the content application. The content server 250 facilitates streaming or downloading of the content.

The virtual bookplate generator 260 is a collection of tools, interfaces, and services enabling a virtual bookplate to be generated and/or customized. The virtual bookplate generator includes a virtual bookplate customizer 262, a digital content item keyword identifier 264, a virtual bookplate editor interface 265, a virtual bookplate feature extractor 266, and a prompt generator 268. In various embodiments, the virtual bookplate generator 260 is implemented as a stand-alone application or as a component within an application that provides other functions. For example, the virtual bookplate generator 260 may be a component of an eBooks application that allows a user to view content. Any application that includes the virtual bookplate generator 260 may be referred to herein as a virtual bookplate generator application. Accordingly, a virtual bookplate generator application may refer to an application with a multitude of different functionalities.

The virtual bookplate customizer 262 includes modules and components for customizing a virtual bookplate and/or for generating a custom virtual bookplate. In various embodiments, a virtual bookplate is generated using one or more of a template, GPIM content, GVM content, recorded audio content, publisher virtual bookplate content, and uploaded data. In other embodiments, a virtual bookplate is provided to the virtual bookplate customizer 262. Some virtual bookplate content is uneditable, such as an author signature or limited-edition number.

In some embodiments, the virtual bookplate customizer customizes or generates a virtual bookplate containing uneditable content. In embodiments, a virtual bookplate with uneditable content that is gifted includes a giftee signature, giftee audio recording, and/or another customization. Alternatively, a virtual bookplate may include uneditable content with a signature and/or message attached or associated therewith.

The digital content item keyword identifier 264 identifies a digital content item keyword for a digital content item. For example, the digital content item keyword identifier 264 extracts a keyword from an eBook that represents a core element of the eBook. The keyword can be included as context in a prompt for generating virtual bookplate content using the GPIM 270.

The virtual bookplate editor interface 265 includes an editor interface for editing a virtual bookplate. In various embodiments, the editor interface 265 includes one or more of the following: a toolbar with tools and options, such as selection tools, drawing tools, cropping tools, text tools, and more; a canvas, where a virtual bookplate image is displayed and edited interactively using the editing tools; a layers panel that facilitates multiple layers within an image; an options panel that displays adjustable settings; a color panel or picker; a history panel that facilitates undo and redo functionality; transform controls; filters; effects; saving and/or exporting function features; and/or other similar features.

The virtual bookplate feature extractor 266 extracts features from various sources as content for a virtual bookplate. The virtual bookplate feature extractor 266 extracts media from websites or social media feeds or profiles. The virtual bookplate feature extractor 266 automates the process of identifying and extracting relevant and/or current media content. The virtual bookplate feature extractor 266 deploys web scraping techniques to crawl and extract content from web pages, including images, videos, and other media files embedded within the HTML markup. The extractor also includes algorithms to detect and identify different types of media content within web pages, such as image URLs, video tags, or audio elements. In the case of social media feeds or profiles, the virtual bookplate feature extractor 266 analyzes content to identify relevant media content and extract associated metadata. Metadata includes various information, such as image dimensions, file size, timestamps, and user tags or mentions. The feature extractor also integrates with platform APIs for social media platforms to access media content and associated metadata directly from user profiles or feeds.

In an embodiment, the feature extractor 266 determines a font used for the eBook and/or a font selected in a user preference. The font used for the eBook and/or the font selected in a user preference is set as a default font for text used to customize the virtual bookplate (i.e., for signature or message text).

The prompt generator 268 generates a prompt for a generative model using one or more digital content item keywords. The prompt optionally includes one or more parameters as context related to a requested image. The one or more parameters can be input by a user or determined according to attributes of the virtual bookplate being customized (i.e., eBook name, publisher name, reason/occasion for virtual bookplate, virtual bookplate formatting/size parameters).

The generative pretrained image model 270 is a pretrained model that generates images based on one or more input criteria. A Generative Pretrained Image Model (“GPIM”) is a type of deep learning model trained to generate new images based on input specifications or conditions. Such models are pretrained on a large dataset of images to learn the underlying patterns and structures of the data. Such models are fine-tuned on specific tasks or datasets. During training, the model learns to generate images that are visually similar to the images in the training dataset. Once trained, the model can generate new images by sampling points from the latent space and passing them through a generator network. The generative pretrained image model 270 generates images based on a prompt received from the prompt generator 268. The virtual bookplate generator 260 generates virtual bookplates, including the results of the generative pretrained image model 270 as virtual bookplate content.

The generative voice model 275 is a model that is trained on voice recordings to generate speech mimicking the recorded voice from input text that is converted into a digital voice approximating the recording voice. A Generative Voice Model (“GVM”) is a type of deep learning model trained to generate speech samples based on input text. Such models are trained on large datasets of voice recordings paired with corresponding text transcripts to learn the relationship between text and speech. GVMs can convert input text into speech that mimics the characteristics of the recorded voice used for training, including cloning a specific voice from a dataset to generate speech in that voice from input text.

Virtual bookplate content can be provided to the virtual bookplate customizer 262 as follows: the feature extractor 266 loads images or other media from various sources for use by the virtual bookplate customizer 262. The keyword identifier 264 identifies a keyword based on the digital content item. The prompt generator 268 generates a prompt based on the keyword and provides the prompt to a GPIM. The results of the GPIM are displayed in the editor for selection. Also, user input is received via the virtual bookplate editor interface 265. Various user input is received to sign, add a message to, alter, add content to, remove content from, or otherwise adjust, design, edit and/or confirm the design for a virtual bookplate.

The datastore 280 is any type of storage unit and/or device (e.g., a file system, database, collection of tables, or any other storage mechanism) for storing data. The datastore 280 may include multiple different storage units and/or devices. The multiple different storage units and/or devices may or may not be of the same type or located at the same physical site. Further, the datastore 280 may be implemented or executed on the same computing system as the client device(s) 210, the account server 240, and/or the content server 250. Additionally, or alternatively, a datastore 280 may be implemented or executed on a computing system separate from the client device(s) 210, the account server 240, and the content server 250. The datastore 280 may be communicatively coupled to the client device(s) 210, the account server 240, and/or the content server 250 via a direct connection or via a network.

The datastore 280 stores various data used by the system 200 including, but not limited to, digital content item data 281, virtual bookplate data 282, account data 283, application data 284, publisher data 285, preferences data 286, recorded audio data 287, and/or uploaded data 288.

Information describing the client device(s) 210, the account server 240, and/or the content server 250 may be implemented across any of components within the system 200. However, this information is illustrated within the datastore 280 for purposes of clarity and explanation.

Digital content item data 281 refers to data related to the digital content items within the system, such as eBooks content or other content application data. Digital content item data includes eBook content as well as title, author, genre, publication date, summary, and associated metadata for the eBook item.

Virtual bookplate data 282 refers to information related to a virtual bookplate. Virtual bookplate data includes virtual bookplate content, such as images or text, as well as data for the name of the purchaser, name of the recipient, date of purchase, message, edition number, author signature, and/or an associated eBook identifier.

Account data 283 refers to data related to user accounts for the content application(s) 220, such as user profiles, authentication credentials, and account settings. Examples of data types related to user accounts include the following: username, email address, password (hashed), profile picture, and user preferences.

Application data 284 refers to data related to the content application 220, including configuration settings, logs, analytics data, usage statistics, error logs, performance metrics, and/or other application data.

Publisher data 285 refers to data related to publishers or content providers such as content publisher 290. Publisher data includes information about digital content item availability, contracts, and royalties, publisher names, contact information, publishing agreements, ISBNs, sales data, and/or other publisher data.

Preferences data 286 includes user-specific preferences and settings, such as eReader settings, virtual bookplate display settings, display preferences, notification settings, and language preferences, theme preference, font, font size, notification sound preferences, language settings, and/or other preferences data.

Recorded audio data 287 refers to audio recordings stored within the system. In various embodiments, recorded audio data 287 includes audiobook data, eBook narration, and/or virtual bookplate recordings. Recorded audio data 287 also includes file title, duration, author, and/or other associated metadata.

Uploaded data 288 includes any user-generated content or files uploaded to the system. In embodiments, uploaded data 288 includes sound recordings, documents, images, and/or videos that may be saved by the system 200 and/or used as custom virtual bookplate content.

The content publisher 290 is an entity that is a source of eBook content 292 and/or virtual bookplate content 294. For example, the content publisher 290 is a publisher that publishes eBook content 292 and licenses and/or sells rights to the eBook content 292 to the content store 230. The content publisher 290 also produces virtual bookplate content 294. The virtual bookplate content 294 includes content for inclusion within a virtual bookplate available for purchase or selection via the virtual bookplate store 234. The virtual bookplate content 294 can include a copyrighted image, an edition or serialization number (or limited-edition serialization number), an author signature, and/or another digital content item related to a published eBook.

### Example Method of Generating a Virtual Bookplate

To enable the reader to obtain a clear understanding of the technological concepts described herein, the following processes describe specific steps performed in a specific order. However, one or more of the steps of a particular process may be rearranged and/or omitted while remaining within the contemplated scope of the technology disclosed herein. Moreover, different processes, and/or steps thereof, may be combined, recombined, rearranged, omitted, and/or executed in parallel to create different process flows that are also within the contemplated scope of the technology disclosed herein. Additionally, while the processes below may omit or briefly summarize some of the details of the technologies disclosed herein for clarity, the details described in the paragraphs above may be combined with the process steps described below to get a more complete and comprehensive understanding of these processes and the technologies disclosed herein.

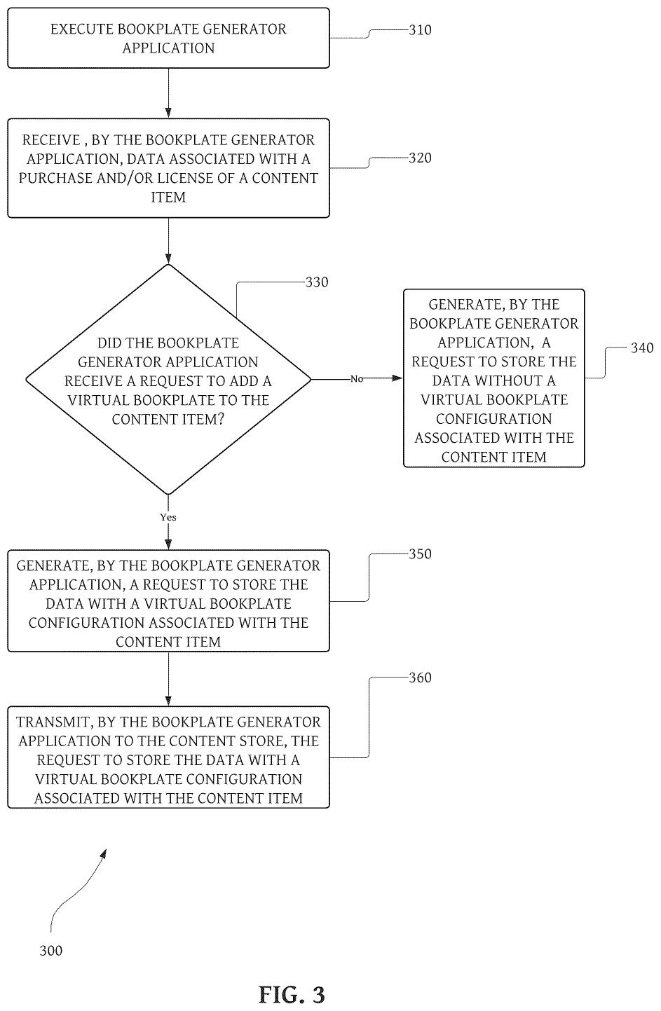

FIG. 3 is a flow diagram of an example process 300 for requesting a virtual bookplate for a digital content item such as an eBook. In FIG. 3, the process 300 begins with a user device launching, executing, or otherwise accessing a virtual bookplate generator application (Operation 310). In various embodiments, the virtual bookplate generator application receives data associated with a purchase and/or license of a content item, determines if a request to add a virtual bookplate to the content item is received, and/or generates a virtual bookplate and/or virtual bookplate configuration responsive to the request.

The virtual bookplate generator application receives data associated with a request to purchase and/or license a content item (Operation 320). In an example, the virtual bookplate generator application presents content that is available for purchase. The virtual bookplate generator application receives a request from a user (referred to herein as a “buyer”) to purchase a content item for another user (referred to herein as a “licensee”). The request may include an identifier (e.g., email or user_id) corresponding to the licensee so that the purchased content item may be assigned to an account associated with the licensee. The request may further include a request for a virtual bookplate to be associated with the copy of the content item that is assigned to the account associated with the licensee.

The virtual bookplate generator application determines if a request to add a virtual bookplate to the content item has been received (Operation 330). In an example, input requesting a virtual bookplate is provided via the user input. Input requesting a virtual bookplate is received from a checkbox or other selectable element simultaneous to or before the selection of the digital content item. Additionally, or alternatively, an interface is presented on the user device after selection of the digital content item, prompting the user for user input indicating whether a virtual bookplate is requested for the content item.

In various embodiments, the user input requesting the virtual bookplate is received in response to a prompt interface displayed on the user device after the user selects the digital content item. The prompt may ask a user to indicate whether the user would like to add a virtual bookplate to the content item being purchased. When a virtual bookplate is selected by a user, one or more virtual bookplate elements are presented to the user via the user device. User input requesting virtual bookplate elements is used to define a virtual bookplate configuration. The user provides input specifying the desired content and design elements for the virtual bookplate configuration to be created. The user selects options, such as text, font, imagery, or other customization preferences, for the virtual bookplate configuration.

If the system determines there is no request to add a virtual bookplate to the content item, the virtual bookplate generator application generates a request to store the data associated with the purchase and/or license of the content item without a virtual bookplate configuration associated with the content item (Operation 340). For example, the virtual bookplate generator requests to store the data associated with purchasing an eBook without a virtual bookplate configuration associated with the content item responsive to the virtual bookplate generator determining that there is no request to add a virtual bookplate to the eBook.

If the system determines there is a request to add a virtual bookplate to the content item, the virtual bookplate generator application generates a request to store the virtual bookplate configuration in association with the purchased copy of the content item (Operation 350). In an example, the virtual bookplate generator application transmits both the data identifying a purchase or license of the content item and the corresponding virtual bookplate configuration. In embodiments, information about a virtual bookplate configuration is received from the purchaser or requesting entity for the virtual bookplate. The request to store the virtual bookplate data includes the virtual bookplate configuration data as specified by the requesting entity.

In an embodiment, the system receives a request for a virtual bookplate without receiving any identification of a content item to which the virtual bookplate is to be applied. In an example, the system receives a request from a purchaser to purchase a gift card for a target user along with information specifying content for a virtual bookplate (e.g., “with love, from grandma”). The system stores a virtual bookplate configuration indicating content for a virtual bookplate, in association with the gift card. The system transmits the information corresponding to the purchased gift card and the virtual bookplate configuration to a content store. The content store notifies the target user of the gift card. When the content store receives a request to purchase a content item with the gift card, the content store automatically adds the virtual bookplate to the content that was purchased with the gift card.

Continuing with FIG. 3, the virtual bookplate generator transmits the request to store the data associated with the purchase and/or license of the content item with the virtual bookplate configuration associated with the content item (Operation 360). The virtual bookplate generator transmits the request with the virtual bookplate configuration associated with the content item to the content store and/or to another data storage location.

### Example Method of Providing a Virtual Bookplate

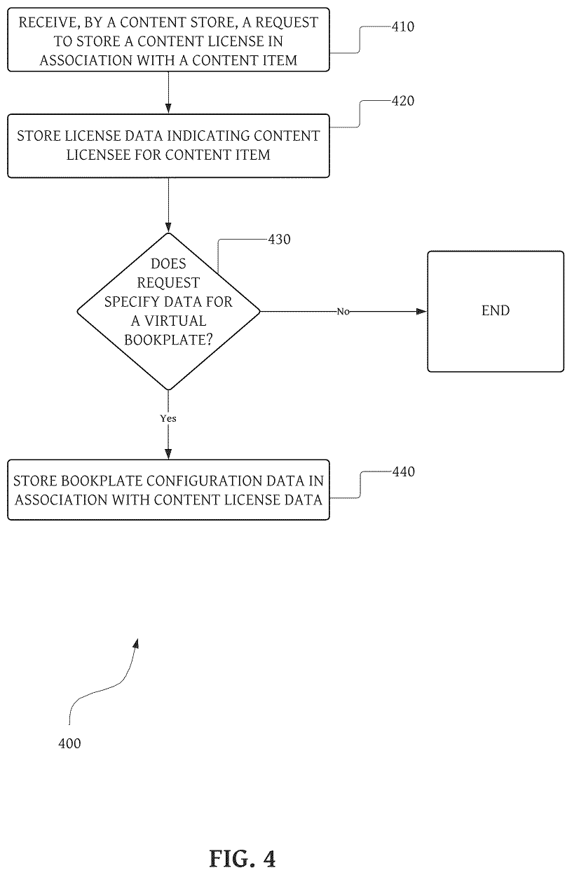

FIG. 4 is a flow diagram of an example process 400 for providing a virtual bookplate and/or for storing virtual bookplate configuration data. For example, a content store stores virtual bookplate configuration data that is used to define a virtual bookplate which is used by the virtual bookplate system 100 of FIG. 1. The content store executes the process 400 to store virtual bookplate configuration data in association with the purchase, license, or other selection of a digital content item. For example, one or more virtual bookplates and/or virtual bookplate configurations are stored by the content store 150 of the system 100.

In FIG. 4, the process 400 begins with a content store receiving a request to store data related to a purchase and/or license of a content item (Operation 410). For example, a user logs in to a user account for an application executing on the user device. The application is used to access a content store, where content for the application is available to be purchased, licensed, and/or otherwise selected. When a digital content item is purchased, licensed, or otherwise selected, a request to store data related to the selection of the digital content item is received by the content store.

The content store stores the data related to the purchase, licensing, and/or other selection of the digital content item (Operation 420). The data related to a purchased, licensed, or otherwise selected content item includes information about a target owner of the content item. For example, a first user uses a first user account to purchase an eBook as a gift for a second user, and the data related to the first user purchasing the eBook as a gift for the second user is stored in association with a second user account for the second user.

The content store determines if the request to store data related to the selection of the digital content item specifies data for a virtual bookplate (Operation 430). If the request to store data related to the selection of the digital content item does not specify a virtual bookplate, the process 400 concludes.

If the request to store data related to the selection of the digital content item does specify a virtual bookplate, the content store stores virtual bookplate configuration data in association with the data related to the purchase, licensing, and/or other selection of the digital content item (Operation 440).

In an example, the digital content item has a unique identifier such as a content identification number associated with the digital content item. The virtual bookplate has a unique identifier such as a virtual bookplate identification number. eBooks and associated virtual bookplates are linked by unique identifiers. For example, a table of information is used to determine what, if any, virtual bookplate identifiers and/or account identifiers are associated with a particular eBook identifier. The application communicates with an account server to determine the digital content items and/or virtual bookplates associated with an account by determining if identifiers exist for the digital content items and/or virtual bookplates.

### Example Processes for Selecting and/or Presenting a Virtual Bookplate

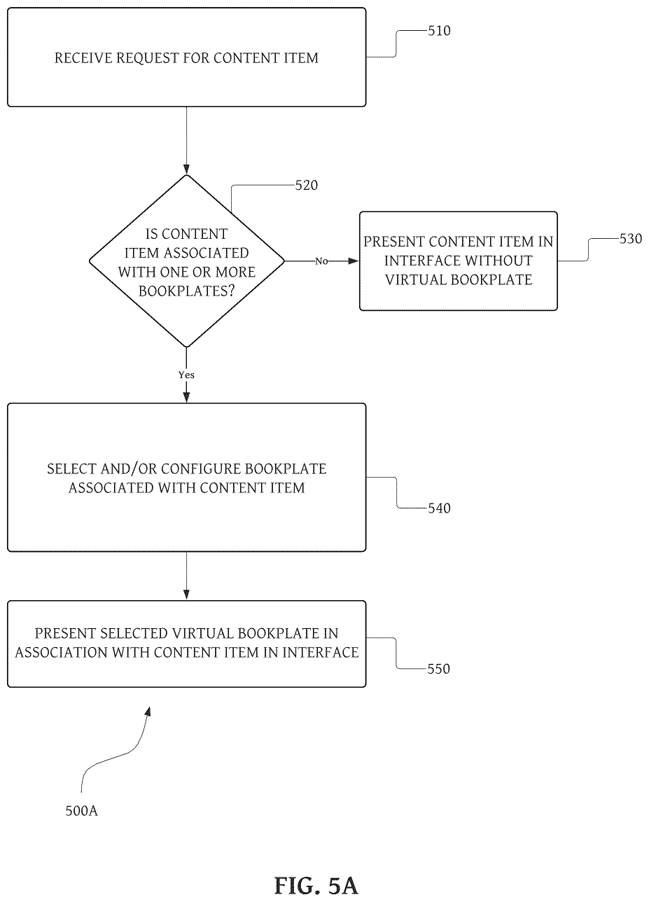

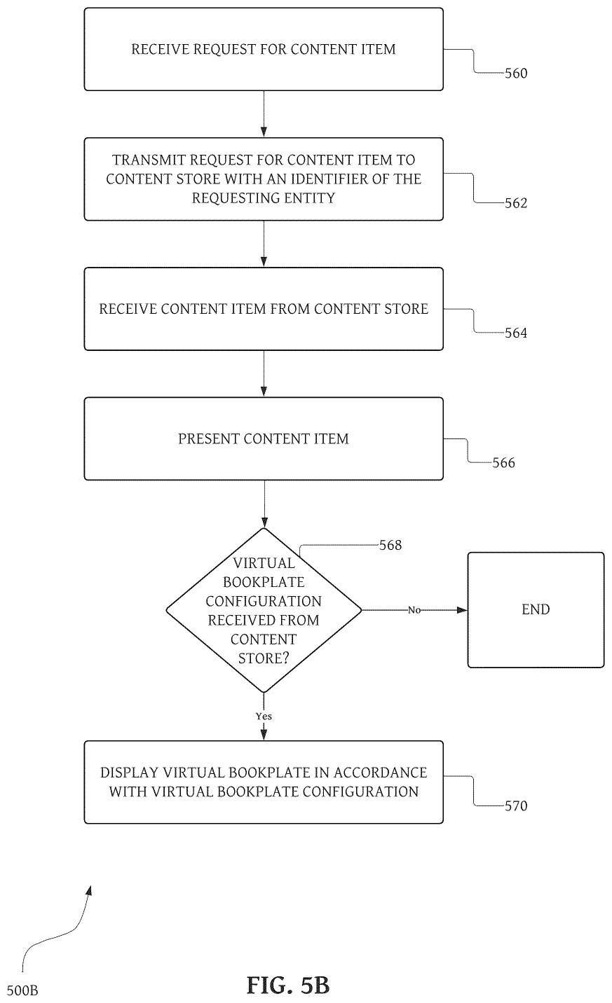

FIG. 5A is a flow diagram of an example process 500A for presenting a virtual bookplate in association with a digital content item. The process 500A may be executed by a content viewer application such as the content viewer application 220 of FIG. 2 to cause a virtual bookplate to be presented in association with a digital content item on a user device.

In FIG. 5A, the process 500A begins with the content viewer application receiving a request for a digital content item (Operation 510). In an embodiment, a user of a user device launches a content application such as an eReader application. The user navigates to a content selection interface of the eReader and selects an eBook that the user would like to open. The selection of the eBook results in a request for the eBook content item.

The content viewer application determines if a copy of the digital content item that has been purchased for the user is associated with one or more virtual bookplates (Operation 520). In embodiments, the user's copy of the digital content item has a unique identifier, and determining if the digital content item is associated with one or more virtual bookplates includes determining if there are any virtual bookplate identifiers associated with the digital content item identifier, such as by being correlated in a table or database. In other embodiments, the digital content item includes a pointer to a virtual bookplate, metadata referencing a virtual bookplate, and/or a structural link to a virtual bookplate.

If the content viewer application determines the digital content item is not associated with one or more virtual bookplates, the content viewer application presents the digital content item in an interface without a virtual bookplate (Operation 530). In an example, a user has access to many eBooks owned by the user's account. The eBooks belonging to the user's account are listed in the eReader application. The eReader application has a customizable selection of eBook attributes for listed eBooks. For example, an eBook in the list may include the title, author, a thumbnail, page length, publisher, completion indicator, and/or virtual bookplate indicator. The virtual bookplate indicator indicates if a virtual bookplate is associated with the eBook and/or attributes of the virtual bookplate, such as a name or signature.

If the content viewer application determines the digital content item is associated with one or more virtual bookplates, the system selects and/or configures a virtual bookplate associated with the digital content item (Operation 540). In the case of just one virtual bookplate being associated with the digital content item, the content viewer application selects the one virtual bookplate. If more than one virtual bookplate is associated with the digital content item, the content viewer application selects a virtual bookplate based on a user selection, most recent use, user preference, random selection, specified order or rotation, time of day, last-viewed location of the digital content item, or another criteria or combination of criteria. In some embodiments, content viewer application configures a virtual bookplate (a) responsive to the request for the content item and (b) using a virtual bookplate configuration associated with the content item.

Next, the system presents the selected virtual bookplate in association with the digital content item in an interface (Operation 550). The virtual bookplate is formatted based on attributes of the content viewer application. The virtual bookplate is formatted based on attributes of the user device. For example, the virtual bookplate is scaled to correspond to a portion of the size of an eBook page and/or based on a resolution of a display of the user device executing the eReader application or is otherwise dynamically transformed based on characteristics of an associated eReader or user device.

FIG. 5B is a flow diagram of an example process 500B for presenting a virtual bookplate in association with a digital content item. The process 500B may be used by the virtual bookplate system 100 of FIG. 1 to cause a virtual bookplate to be presented in association with a digital content item on a user device executing a content application.

In FIG. 5B, the process 500B begins with the system receiving a request for a digital content item (Operation 560). In an embodiment, a user of a user device launches an eReader application. The user navigates to a content selection interface of the eReader and selects an eBook that the user would like to open. The selection of the eBook results in a request for the eBook content item.

The content viewer application transmits, to a content store, a request for the content item with an identifier of the requesting entity (Operation 562). For example, a user logs into the content viewer application using a user account. The user account has an account identifier associated with the account. The content store determines if the content item belongs to the account by determining whether a content item identifier for the content item is associated with the account identifier for the account in such a way that reflects ownership of the content item by the account.

Continuing the example, the content viewer application receives the content item from the content store (Operation 564). Once the content store verifies that the account requesting the content item is authorized to access the content item, the content item is transmitted to the content viewer application. Data for the content item is transmitted from the content store, a content server, and/or another data storage location. For example, the content viewer application requests an eBook from an eBook virtual storefront and receives eBook data from a content server associated with the eBook virtual storefront.

The content viewer application presents the content item (Operation 566). In the example of a content item that is an eBook, an eReader application presents the cBook on a display of a computing device. The content viewer application determines if a virtual bookplate configuration has been received from the content store. (Operation 568). If the content viewer application determines that no virtual bookplate configuration has been received from the content store, the process 500B concludes.

If the content viewer application determines that a virtual bookplate or virtual bookplate configuration has been received from the content store, the content viewer application displays the virtual bookplate or displays a virtual bookplate in accordance with the virtual bookplate configuration. In embodiments, a virtual bookplate configuration includes a definition or instructions determining the appearance and/or contents of a virtual bookplate. Also, a virtual bookplate configuration includes a definition or instructions determining when and/or where the virtual bookplate is presented relative to the contents of the content item (e.g., before viewing the content item, simultaneous to viewing the content item, on a separate page from a portion of the content item, overlaid onto a portion of the content item, etc.). Virtual bookplate configurations determine or define what contents will be included for virtual bookplates responsive to the content item being accessed via the content viewer application. For example, a virtual bookplate configuration defines a virtual bookplate that includes content extracted from a web-based content source using an API call to the web-based content source to extract the most recent content. In embodiments, virtual bookplate configurations are defined based on user input from a purchaser, based on a definition provided by a publisher, and/or based on another definition.

### Example of Using a Virtual Bookplate System

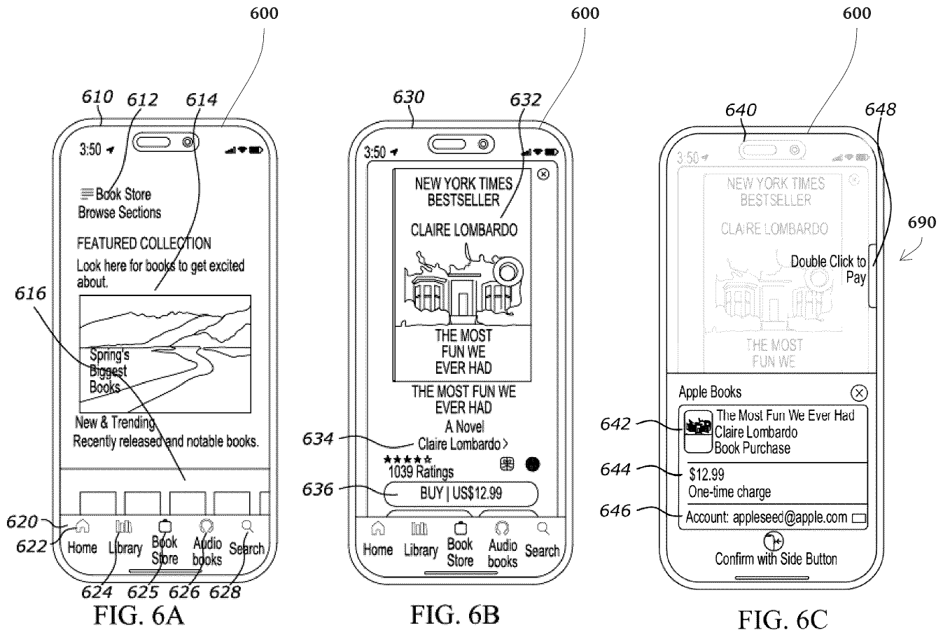

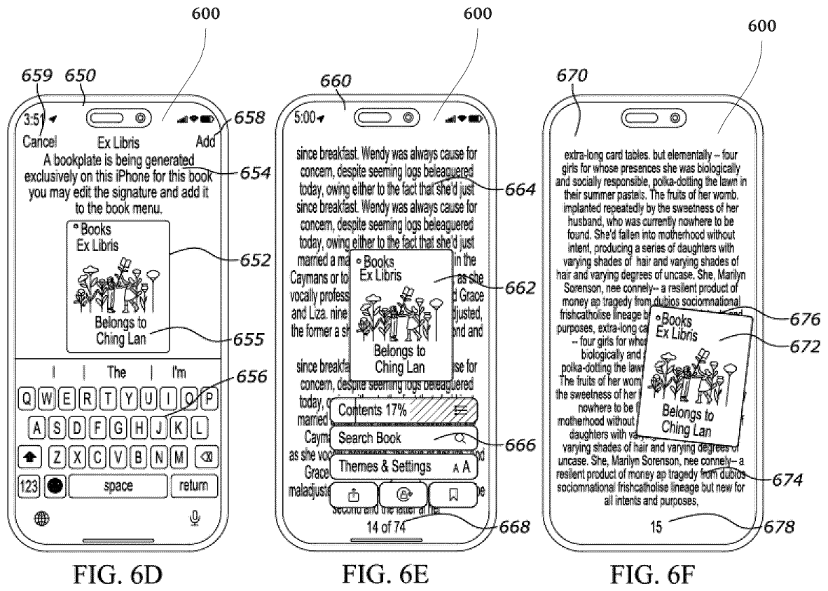

FIGS. 6A-6F illustrate an example of using a virtual bookplate system. In FIGS. 6A-6F, a computing device 600 executes an eReader application. In the example, the computing device 600 is a smart phone. However, in alternative embodiments, the computing device 600 is a tablet, computer, or other eReading device. In the example, the computing device 600 accesses an eBook store using an application displaying various user interfaces for using the virtual bookplate system.

In FIG. 6A a first interface 610 includes a bookstore menu 612, a content element 614, a trending content element 616, and a navigation menu 620.

In this example, the bookstore menu 612 provides navigation tools for browsing content available for purchase or selection. The bookstore menu 612 expands into a list of menu items providing searching and organizing features to a user.

The content element 614 shows a list of bookstore content available for purchase or selection for adding to a user account. The content element 614 includes a display of the most popular eBooks, suggested eBooks targeted for a user account, or some other selection of eBooks. The trending content element 616 includes a display of new or trending eBooks, such as by providing a grid or list of icons displaying respective covers of the trending eBooks and/or related information.

The navigation menu 620 includes a home button 622, a library button 624, a bookstore button 625, an audio books button 626, and a search button 628. The navigation menu provides a set of controls used to move between different sections or features of the eBook store.

The home button 622 provides a shortcut that takes users to a home page or starting page of the eBook store. The library button 624 provides a shortcut that takes users to a user's personal eBook collection, where users view the eBooks the users have purchased or downloaded and/or any associated virtual bookplates. This section also includes management and organization features, allowing users to sort their eBooks and virtual bookplates into collections or lists and/or to gift or trade eBooks and/or virtual bookplates.

The bookstore button 625 provides a shortcut that takes users to a section of the application where the users can browse and purchase eBooks. For example, the bookstore button 625 provides a shortcut that takes users to the first interface 610.

The audio books button 626 provides a shortcut that takes users to a section of the content store dedicated to audiobooks. At the audiobook section, users can browse, purchase, and/or listen to samples of audiobooks available in the store.

The search button 628 provides a shortcut that takes users to a text field that allows users to input text to quickly find specific books by matching relevant keywords, such as the title, author, or genre. This feature helps users efficiently locate specific items in the store without having to browse through potentially large catalogs manually.

In FIG. 6B a second interface 630 includes an eBook icon 632, eBook information display 634, and a selection button 636. A user navigates from the first interface 610 to the second interface 630 upon selecting an eBook, such as by touching or clicking on an eBook of the content element 614 or the trending content element 616.

The eBook icon 632 displays a graphic associated with the eBook, such as a cover image or other image associated with the eBook. The eBook information display 634 includes various information, such as title, publisher, year, ranking, rating, price, discount, and/or other information. The selection button 636 confirms that a particular eBook is selected for purchase, download, or adding to an account. The selection button 636 includes a confirmation message, such as “Buy,” “Confirm purchase,” or “Proceed to checkout,” and/or price of purchase. The selection button 636 includes a link that takes the user to the third interface 640.

In FIG. 6C a third interface 640 includes a selection summary element 642, a selection confirmation 644, account information 646, and an authorization instruction 648.

The selection summary element 642 displays a summary of a user's selection of the book or audiobook the user is intending to purchase or download. This summary includes details, such as the title, author, price, and quantity selected.

The billing confirmation 644 allows users to confirm their intent to purchase the items listed in the selection summary using billing information displayed in the billing confirmation 644. The billing confirmation 644 includes a charge amount and/or frequency.

The account information 646 displays the account details for the user account purchasing or selecting the content item. The account information includes types of information, such as recipient account name, preferred payment method, and/or other account information.

The authorization instruction 648 is a textual instruction describing a command for authorizing the transaction. In the example, the authorization instruction 648 is an instruction for a user to double-click a side button 690 of the computing device 600 to confirm the transaction. In this example, performing the authorization instruction 648 (e.g., double-clicking the side button of the computing device 600) adds the eBook to the target user account. In this example, performing the authorization instruction also directs the user to the fourth interface 650. In some embodiments, performing the authorization instruction requires the user to enter their password or to use a biometric verification (like a fingerprint or facial recognition).

In FIG. 6D a fourth interface 650 includes a virtual bookplate display 652, a virtual bookplate interface message 654, a virtual bookplate content message 655, a keyboard 656, an add button 658, and a cancel button 659. Using the fourth interface 650, a user enters a virtual bookplate message and/or a virtual bookplate signature into the computing device 600.

The virtual bookplate display 652 presents virtual bookplate content belonging to the virtual bookplate. In various embodiments, the virtual bookplate content includes eBook information, a GPIM image, a message and/or signature from a purchaser, or other virtual bookplate content. In some embodiments, the virtual bookplate display 652 is editable using a virtual bookplate editor. For example, interacting with a portion of the fourth interface (such as touching the virtual bookplate display 652) allows a user to edit portions of the virtual bookplate before saving a virtual bookplate design or template.

The virtual bookplate interface message 654 provides instructions or information about the virtual bookplate being generated and/or how to save or edit the virtual bookplate. The virtual bookplate content message 655 includes text input via the client device, such as a personalization message or signature. In the example, a user types the virtual bookplate content message 655 using the keyboard 656.

Once the virtual bookplate is complete and/or any messages have been added, a user adds the virtual bookplate to the eBook using the add button 658. If the user does not wish to add a virtual bookplate to the eBook, the user uses the cancel button 659 to return to the first interface 610 or to a home page.

In FIG. 6E, a fifth interface 660 includes a virtual bookplate display 662, eBook textual content 664, an eReader menu interface 666, and an eBook page number 668. The fifth interface 660 depicts an eReader application presenting an eBook for which a virtual bookplate has been added. The fifth interface modifies a traditional eReader display at least by including the virtual bookplate display 662 overlaid onto the eBook textual content 664. In embodiments, the virtual bookplate display 662 may be displayed in the margins, wrapped by text, used as a background, or otherwise presented with the eBook textual content 664.

In alternative embodiments, when the eBook is opened, the virtual bookplate is displayed before the eBook contents. For example, the virtual bookplate is displayed until a user touches the screen of the user device to proceed to the eBook contents.

The eReader menu interface 666 includes navigable menu items for adjusting themes, settings, or preferences associated with the eBook and/or virtual bookplate. The menu interface 666 also includes various features, such as a search bar, progress bar, share button, display rotation lock button, bookmark button, and/or the like. The eBook page number 668 displays a current page number (i.e., for the page being read or for a search result) and a total page number for the eBook.

In FIG. 6F a sixth interface 670 includes a virtual bookplate display 672, eBook text contents 674, a virtual bookplate icon edge 676, and a page number 678. The sixth interface 670 illustrates states of the eReader application associated with opening or closing an eBook.

In FIG. 6F, the virtual bookplate display 672 is overlaid onto the eBook text content 674. In the example, the sixth interface 670 depicts a viewer mode of the eReader application. In this mode, the eBook contents 674, the virtual bookplate display 672, and a page number 678 are shown without necessarily displaying other graphical elements (i.e., icons for clock, compass, signal strength, battery status, etc.).

In FIG. 6F, the virtual bookplate display 672 is shown at a location (e.g., at a specific page) of the eBook associated with a currently read or previously read page. For example, when an eBook is opened, an animation is displayed showing the virtual bookplate moving from a previously read portion of the eBook. When the eBook is closed, an animation is shown displaying the virtual bookplate moving to a current portion of the eBook. In this way, the virtual bookplate is used as a virtual bookmark. In an embodiment, the virtual bookplate display 672 is shown when a user initiates the closing of an eBook. The user uses a touchscreen of the computing device 600 to move the virtual bookplate to a desired location, such as by dragging an edge 676 of the virtual bookplate at a spot to be bookmarked. When the eBook is next opened, the virtual bookplate is initially displayed at the same location.

### Example Process for Generating and Editing a Virtual Bookplate

Designing a virtual bookplate involves several steps. Firstly, a virtual bookplate system receives a request from a user device to generate a virtual bookplate for a specific digital content item such as an eBook. Next, the system retrieves an account history associated with the digital content item, including any previous virtual bookplates created for the item or related user preferences. The system then checks if a predefined virtual bookplate template exists for the digital content item, potentially using this template as a starting point for the design process. The system receives text input from the purchaser device; this input may include personalized messages, dedications, or other textual content to be included on the virtual bookplate. The system analyzes the digital content item to extract relevant keywords that can be incorporated into the virtual bookplate design. The system also extracts the font or typography used in the digital content item to provide consistency in design elements between the virtual bookplate and the associated content.

The system provides the extracted keyword to a generative model designed to generate relevant images or visual elements based on input keywords. Using the extracted font, generated images, and text input from the purchaser device, the system generates proposed virtual bookplate designs that may include key images, personalized messages, and other graphical elements. Users can then add additional features or customize the proposed virtual bookplate design, such as by adding borders, decorative elements, or color schemes, based on their preferences. Any edits or modifications to the proposed virtual bookplate design from the purchaser device are received by the system, allowing users to fine-tune the design to their liking.

Once the design is finalized, the system prompts the user to confirm the virtual bookplate design before proceeding to the next step. After confirmation, the system locks the virtual bookplate design to prevent further edits or modifications. Finally, the system generates the virtual bookplate for the digital content item using the locked virtual bookplate design that may be used in accordance with a related virtual bookplate system.

### Example Virtual Bookplate Audio Content

In various embodiments, a virtual bookplate is created with an audio element. In an example, the audio element includes a recorded message. The recipient of the eBook is able to listen to the audio element recorded in association with the virtual bookplate. The audio element includes a recorded message from a purchaser of the eBook, an author or producer of the eBook, and/or another entity. Alternatively, the audio element is generated using a GVM. The GVM is trained using recorded speech from the purchaser. In other embodiments, the GVM is trained on other recorded speech. In a particular embodiment, the GVM is used to generate voice narration for the eBook.

### Example Virtual Bookplate Tracker Content

In various embodiments, a virtual bookplate is created with a library card and/or activity tracking features. For example, the virtual bookplate includes a history of when an associated eBook is opened and/or closed as well as various statistics associated with the eBook, such as total pages read, total time spend opened, number of times opened, time since last eBook was last opened, and/or the like. The meeting of certain criteria, such as completing an eBook, is tracked and reflected in the virtual bookplate contents.

### Example Virtual Bookplate Collection Interface

In various embodiments, virtual bookplates owned by a user account are viewable and/or arrangeable in a virtual bookplate collection interface associated with a content viewer application. The virtual bookplate collection interface enables a user to view a library of owned virtual bookplates. The collection interface also enables a user to view a set of virtual bookplates corresponding to a particular eBook. Using the collection interface, a user selects a virtual bookplate from the set of virtual bookplates to be used with the corresponding eBook.

### Graphical User Interfaces

This disclosure above describes various Graphical User Interfaces (GUIs) for implementing various features, processes, or workflows. These GUIs can be presented on a variety of electronic devices, including but not limited to laptop computers, desktop computers, computer terminals, television systems, tablet computers, e-book readers, and smart phones. One or more of these electronic devices can include a touch-sensitive surface. The touch-sensitive surface can process multiple simultaneous points of input, including processing data related to the pressure, degree, or position of one or more points of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping, or gesturing with one or more fingers or stylus on a user interface element. User interface elements can be virtual buttons, menus, selectors, switches, sliders, scrubbers, knobs, thumbnails, links, icons, radio buttons, checkboxes, and any other mechanism for receiving input from, or providing feedback to a user.

### Privacy

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data in the present technology can be used to the benefit of users. For example, the personal information data can be used to deliver targeted content that is of greater interest to the user. For example, the personal information data may be used by a prompt generator to generate a prompt for a generative model for virtual bookplate generation or customization. Accordingly, use of such personal information data enables calculated control of the delivered content. Furthermore, other uses for personal information data that benefit the user are also contemplated by the present disclosure. For instance, health and fitness data may be used to provide insights into a user's general wellness, or the health and fitness data may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Furthermore, such collection/sharing should occur after receiving the informed consent of the users. Additionally, such entities should consider taking any needed steps for safeguarding and securing access to such personal information data and ensuring that others with access to the personal information data adhere to their privacy policies and procedures. Furthermore, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA), whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participating in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, the present disclosure notes that some personal information data is sensitive and therefore is managed in a way to minimize risks of unintentional or unauthorized access or use. Risk can be minimized by limiting the collection of data and deleting data once the data is no longer needed. In addition, and when applicable, including in certain health-related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of personal information data. For example, content can be selected and delivered to users by inferring preferences based on non-personal information data or a bare minimum amount of personal information, such as the content being requested by the device associated with a user, other non-personal information available to the content store, or publicly available information.

### Example System Architecture

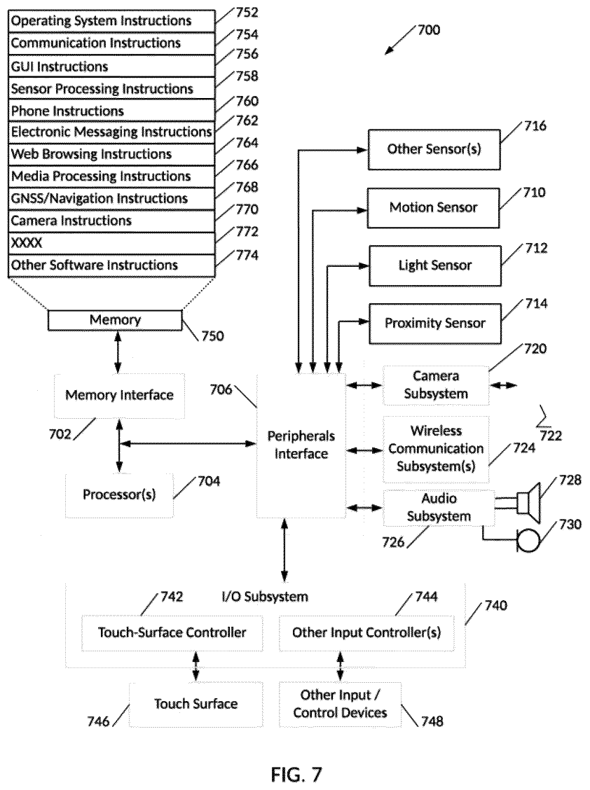

FIG. 7 is a block diagram of an example computing device 700 that can implement the features and processes of FIGS. 1-6F. The computing device 700 can include a memory interface 702, one or more data processors, image processors and/or central processing units 704, and a peripherals interface 706. The memory interface 702, the one or more processors 704, and/or the peripherals interface 706 can be separate components or can be integrated in one or more integrated circuits. The various components in the computing device 700 can be coupled by one or more communication buses or signal lines.

Sensors, devices, and subsystems can be coupled to the peripherals interface 706 to facilitate multiple functionalities. For example, a motion sensor 710, a light sensor 712, and a proximity sensor 714 can be coupled to the peripherals interface 706 to facilitate orientation, lighting, and proximity functions. Other sensors 716 can also be connected to the peripherals interface 706, such as a global navigation satellite system (GNSS) (e.g., GPS receiver), a temperature sensor, a biometric sensor, magnetometer, or other sensing device, to facilitate related functionalities.

A camera subsystem 720 and an optical sensor 722, e.g., a charged coupled device (CCD) or a complementary metal-oxide semiconductor (CMOS) optical sensor, can be utilized to facilitate camera functions, such as recording photographs and video clips. The camera subsystem 720 and the optical sensor 722 can be used to collect images of a user to be used during authentication of a user, e.g., by performing facial recognition analysis.

Communication functions can be facilitated through one or more wireless communication subsystems 724 that can include radio frequency receivers and transmitters and/or optical (e.g., infrared) receivers and transmitters. The specific design and implementation of the communication subsystem 724 can depend on the communication network(s) over which the computing device 700 is intended to operate. For example, the computing device 700 can include communication subsystems 724 designed to operate over a GSM network, a GPRS network, an EDGE network, a Wi-Fi or WiMax network, and a Bluetooth™ network. In particular, the wireless communication subsystems 724 can include hosting protocols such that the device 700 can be configured as a base station for other wireless devices.

An audio subsystem 726 can be coupled to a speaker 728 and a microphone 730 to facilitate voice-enabled functions, such as speaker recognition, voice replication, digital recording, and telephony functions. The audio subsystem 726 can be configured to facilitate processing voice commands, voiceprinting, and voice authentication, for example.

The I/O subsystem 740 can include a touch-surface controller 742 and/or other input controller(s) 744. The touch-surface controller 742 can be coupled to a touch surface 746. The touch surface 746 and touch-surface controller 742 can, for example, detect contact and movement or break thereof using any of a plurality of touch sensitivity technologies, including but not limited to capacitive, resistive, infrared, and surface acoustic wave technologies as well as other proximity sensor arrays or other elements for determining one or more points of contact with the touch surface 746.

The other input controller(s) 744 can be coupled to other input/control devices 748, such as one or more buttons, rocker switches, thumbwheel, infrared port, USB port, and/or a pointer device such as a stylus. The one or more buttons (not shown) can include an up/down button for volume control of the speaker 728 and/or the microphone 730.

In one embodiment, a pressing of the button for a first duration can disengage a lock of the touch surface 746, and a pressing of the button for a second duration that is longer than the first duration can turn power to the computing device 700 on or off. Pressing the button for a third duration can activate a voice control, or voice command, module that enables the user to speak commands into the microphone 730 to cause the device to execute the spoken command. The user can customize a functionality of one or more of the buttons. The touch surface 746 can, for example, also be used to implement virtual or soft buttons and/or a keyboard.

In some embodiments, the computing device 700 can present recorded audio and/or video files, such as MP3, AAC, and MPEG files. In some embodiments, the computing device 700 can include the functionality of an MP3 player such as an iPod™.

The memory interface 702 can be coupled to memory 750. The memory 750 can include high-speed random-access memory and/or non-volatile memory, such as one or more magnetic disk storage devices, one or more optical storage devices, and/or flash memory (e.g., NAND, NOR). The memory 750 can store an operating system 752, such as Darwin, RTXC, LINUX, UNIX, OS X, WINDOWS, or an embedded operating system such as Vx Works.

The operating system 752 can include instructions for handling basic system services and for performing hardware dependent tasks. In some implementations, the operating system 752 can be a kernel (e.g., UNIX kernel). In some implementations, the operating system 752 can include instructions for performing operations related to virtual bookplates. For example, operating system 752 can implement the virtual bookplate system features as described with reference to FIGS. 1-6F.

The memory 750 can also store communication instructions 754 to facilitate communicating with one or more additional devices, one or more computers, and/or one or more servers. The memory 750 can include the following: graphical user interface instructions 756 to facilitate graphic user interface processing; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GNSS/Navigation instructions 768 to facilitate GNSS and navigation-related processes and instructions; and/or camera instructions 770 to facilitate camera-related processes and functions.

The memory 750 can store software instructions 772 to facilitate other processes and functions, such as the virtual bookplate system processes and functions as described with reference to FIGS. 1-6F.

The memory 750 can also store other software instructions 774, such as web video instructions, to facilitate web video-related processes and functions and/or web shopping instructions to facilitate web shopping-related processes and functions. In some implementations, the media processing instructions 766 are divided into audio processing instructions and video processing instructions to facilitate audio processing-related processes and functions and video processing-related processes and functions, respectively.

The above identified instructions and applications can correspond to a set of instructions for performing one or more functions described above. These instructions need not be implemented as separate software programs, procedures, or modules. The memory 750 can include additional instructions or fewer instructions. Furthermore, various functions of the computing device 700 can be implemented in hardware and/or in software, including in one or more signal processing and/or application specific integrated circuits.

To aid the Patent Office and any readers of any patent issued on this application in interpreting the claims appended hereto, applicants wish to note that applicants do not intend any of the appended claims or claim elements to invoke 35 U.S.C. 112 (f) unless the words “means for” or “step for” are explicitly used in the particular claim.

What is claimed is:

1. A method comprising:
accessing a request for a digital content item;
identifying a virtual bookplate associated with the digital content item; and
presenting an interface including the virtual bookplate in association with the digital content item,
wherein the method is executed by at least one device including a hardware processor.

2. The method of claim 1, wherein:
presenting the virtual bookplate in association with the digital content item comprises overlaying the virtual bookplate on at least a portion of the digital content item.

3. The method of claim 1, further comprising:
subsequent to accessing the request for the digital content item: generating the virtual bookplate for displaying in association with the digital content item based on a virtual bookplate configuration associated with the digital content item.

4. The method of claim 3, further comprising:
generating the virtual bookplate configuration for the digital content item based on user input from a purchaser of the digital content item.

5. The method of claim 1, wherein:
the virtual bookplate is temporarily overlaid on at least a portion of the digital content item in response to user input selecting a command or option associated with the digital content item.

6. The method of claim 1, further comprising:
determining whether there is any virtual bookplate associated with the digital content item;
wherein the virtual bookplate associated with the digital content item is identified for displaying in association with the digital content item in response to determining that the virtual bookplate is associated with the digital content item.

7. The method of claim 1, further comprising:
prior to identifying the virtual bookplate:
determining that the digital content item is associated with the virtual bookplate based on a virtual bookplate configuration corresponding to the digital content item;
requesting, by a first computing device, the virtual bookplate from a second computing device;
receiving, by the first computing device, the virtual bookplate from the second computing device.

8. The method of claim 1, wherein:
the digital content item is owned or licensed to a particular account in association with the virtual bookplate, and
the virtual bookplate is not associated with other variations of the digital content item that are owned or licensed to other respective accounts.

9. The method of claim 1, wherein:
a format of the virtual bookplate is determined based on attributes of a display of a computing device presenting the interface.

10. The method of claim 1, further comprising:
wherein the virtual bookplate is selected from a plurality of virtual bookplates associated with the digital content item.

11. The method of claim 1, wherein:
the virtual bookplate comprises at least one interface element that includes one or more of: (a) content from a social media feed, (b) a message from a purchaser of the digital content item, or (c) an image selected by the purchaser of the digital content item.

12. The method of claim 1, wherein the digital content item is an eBook.

13. The method of claim 1, wherein:
presenting the virtual bookplate in association with the digital content item comprises displaying text of the digital content item such that the virtual bookplate does not cover the text of the digital content item.

14. The method of claim 1, wherein:
presenting the interface including the virtual bookplate comprises displaying the digital content item and playing a first animation that overlays the virtual bookplate on at least a portion of the digital content item.

15. A non-transitory computer-readable medium including one or more sequences of instructions that, when executed by one or more processors, cause the processors to perform operations comprising:
accessing a request for a digital content item;
identifying a virtual bookplate associated with the digital content item; and
presenting an interface including the virtual bookplate in association with the digital content item.

16. The non-transitory computer-readable medium of claim 15, wherein:
presenting the virtual bookplate in association with the digital content item comprises overlaying the virtual bookplate on at least a portion of the digital content item.

17. The non-transitory computer-readable medium of claim 15, further comprising:
subsequent to accessing the request for the digital content item: generating the virtual bookplate for displaying in association with the digital content item based on a virtual bookplate configuration associated with the digital content item.

18. The non-transitory computer-readable medium of claim 17, further comprising:
generating the virtual bookplate configuration for the digital content item based on user input from a purchaser of the digital content item.

19. The non-transitory computer-readable medium of claim 15, wherein:
the virtual bookplate is temporarily overlaid on at least a portion of the digital content item in response to user input selecting a command or option associated with the digital content item.

20. A system comprising:
one or more processors; and
a non-transitory computer-readable medium including one or more sequences of instructions that, when executed by the one or more processors, cause the one or more processors to perform operations comprising:
accessing a request for a digital content item;
identifying a virtual bookplate associated with the digital content item; and
presenting an interface including the virtual bookplate in association with the digital content item.
